(19) United States
(12) Patent Application Publication
(10) Pub. No.: US 2023/0316199 A1
(43) Pub. Date: Oct. 5, 2023

(54) SYSTEM AND METHOD FOR EVALUATING A POTENTIAL FINANCIAL RISK FOR ORGANIZATIONS FROM EXPOSURE TO CYBER SECURITY EVENTS

(71) Applicant: CYBERWRITE INC., (US)

(72) Inventors: GEORGE RAMI PARIENT, RAMAT HASHARON (IL); URI FLEYDER-KOTLER, KADIMA (IL); NIR PERRY, TEL AVIV (IL)

(21) Appl. No.: 17/712,197

(22) Filed: Apr. 4, 2022

(51) Int. Cl. G06Q 10/06; G06Q 40/08

(52) U.S. Cl. CPC G06Q 10/06375; G06Q 10/067; G06Q 40/08

(57) ABSTRACT

A computerized method for evaluating an organization's potential financial damages caused by cyber security events, including receiving a request to evaluate a specific organization's potential financial damages caused by cyber security event, the request including information about the specific organization, collecting security-based risk indicators about the specific organization, inputting the security-based risk indicators about the specific organization into a model, where the model obtains ranges of financial damages for various security events, and computing a specific potential financial damages for the specific organization according to the security-based risk of the specific organization and the ranges of financial damages.

### FIELD

The invention relates generally to evaluating a potential financial risk for organizations from exposure to cyber security events.

### BACKGROUND

The probability of an intrusion into sensitive corporate data increases, as attackers become more common and more sophisticated. Even the most secure businesses are subject to the risk of an attack that could halt electricity supplies or expose restricted data. Many leading corporations have recently fallen prey to a breach in their data.

Organizations wish to evaluate their financial exposure to a security risk for multiple reasons: 1. When negotiating a cyber insurance agreement with an insurance company, organizations wish to know the sum they'd need to be imbursed for in security attacks. 2. When considering a purchase of a cyber security tool (software, hardware etc.), the organization wishes to compare the potential risk versus the tool's costs. 3. The organization's dependence on a third party that may be exposed to security events.

Lack of knowledge of the organization's financial exposure to security events leads organizations' managers to make inaccurate decisions.

### SUMMARY

In one aspect of the invention a computerized method is provided for evaluating an organization's potential financial damages caused by cyber security events, the method including receiving a request to evaluate a specific organization's potential financial damages caused by cyber security event, the request including information about the specific organization, collecting security-based risk indicators about the specific organization, inputting the security-based risk indicators about the specific organization into a model, where the model obtains ranges of financial damages for various security events, and computing specific potential financial damages for the specific organization according to the security-based risk of the specific organization and the ranges of financial damages.

In some cases the method further includes computing a relative score for the specific organization in specific damage types, the relative score is relative to other organizations in the model.

In some cases the method further includes estimating an expected loss from the specific damage types for the specific organization.

In some cases the method further includes estimating an aggregated loss for the specific organization according to the expected loss for the specific damage types and the probability of occurrence of the specific damage types.

In some cases the method further includes collecting relationship data between the specific organization and a specific third party, and estimating an expected loss for the specific organization for a specific damage type for a security event suffered by the specific third party.

In some cases the method further includes collecting raw data indicating a dependency between the organization and a specific third party, and computing a dependency score between the organization and the specific third party.

In some cases the method further includes associating a security event of the specific third party and financial damage of the specific organization.

In some cases the method further includes generating a data record of each organization including values for the security-based risk indicators and inputting the multiple records into the model.

In some cases the record further includes non-security risk indicators of the organization.

In some cases the security-based risk indicators are unique to each organization in the model.

In some cases the security-based risk indicators include security vulnerabilities of the specific organization.

In some cases the security-based risk indicators include technologies used by the specific organization.

In some cases the method further includes evaluating effectiveness of a security mitigation control on a security event type selected from the multiple security events.

In some cases the method further includes obtaining costs of installing multiple mitigation measures for the specific organization, and generating a matrix defining the effect of each of the multiple mitigation measures on various security event types for the specific organization.

In some cases the method further includes creating a residual score for the specific organization based on internal mitigations.

In some cases the method further includes estimating a cost of the multiple mitigation measures by the attack vectors, and allocating the mitigations cost to the different security event types.

In some cases the method further includes assigning weights that represent the effect of an attack vector on different security event types.

In some cases the method further includes computing the cost of security mitigation controls by security event type.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of training and using a model for evaluating a security risk of an organization, according to an exemplary embodiment of the invention;

FIG. 2 shows a method of training the model to evaluate a security risk of an organization, according to an exemplary embodiment of the invention; and

FIG. 3 shows a method of selecting an optimal security mitigation for reducing a security risk of an organization, according to an exemplary embodiment of the invention.

### DETAILED DESCRIPTION

The invention, in embodiments thereof, discloses evaluating a financial risk for an organization from suffering a security event. The method utilizes information about the specific organization and uses a computerized model to compute relative ranks for the specific organization, relative to other organizations. The relative ranks may represent the specific organization's probability to suffer specific security events, and the relative level at the specific organization is expected to handle various security events. The method may also compute a specific value the specific organization is expected to suffer from certain security events, for example based on the specific organization's size, business sector, geographic location as well as security-related indicators as elaborated below. The risk score is computed for each organization by creating a risk profile mapping and comparing the risk profile of a specific organization to risk profiles of other organizations, for example in association of a specific event type. The method also includes computing a potential financial damage the specific organization may suffer if the specific organization suffers a security event.

The risk profile of an organization is created by a computerized model that receives as input cyber and non-cyber risk indicators. The risk may be internal for an organization or due to services received from third-party entities cooperating with the organization, for example as vendors, partners, design partners, clients and the like. The methods may also include comparing an organization's risk profile to other organizations' risk profile, to compute the organization's benchmark risk score. The benchmark risk score may be computed for a specific event type or for the total organization's security risk.

The risk profile can be utilized in several different cases. For example 1) specific organization's own cyber risk assessment, 2) third-party entity cyber risk posed on a specific organization, 3) assessing the organization's exposure to cyber security events or attacks for cyber insurance prepossess.

Evaluating the financial risk of a specific organization may include four processes 1. Data collection. 2. Estimating the potential economic impact for each damage type, or type of a security event. 3. estimating the aggregated economic impact of all the damage types combined. 4. Estimating the probable economic impact.

For use cases 1 and 3 the data collection process includes collecting data on a specific organization. The data includes, for example, the amount and type of data held by the specific organization or at a server, the number of employees in the organization, the type and expertise of the organizations' employees, risk indicators of the organization and the like.

For use case 2 the data collection process will include of collecting data from the specific organization about the type of interactions it has with third parties. The data includes, for example, the amount and type of data held on a database operated by third parties on behalf of the organization, the number of employees the third party has, type and expertise of the third parties' employees, risk indicators of the third parties and the like.

The process of estimating the potential economic impact for each risk type is performed using the collected data about the specific organization or the specific third party and its interactions with a specific organization. The estimation is performed by breaking down each of the risk types into their known ranges of loss. A specific value in the range for each damage type may then be calculated by the model using a profile score of the specific organization in use cases 1 and 3 or of a third party in use case 2. Other examples provided below may consider the specific organization for use cases 1 and 3 and the third party for use case 2. The profile score represents the probability for the specific organization to suffer a security event. The specific organization's score is used for specific event types or combinations of event types. Adjustment is done on a Risk Type level. If the specific organization's score is higher than the benchmark, the computed potential loss will be reduced. If the specific organization's score is lower than the benchmark, the computed potential loss will be increased. That way the risk level of each type of damage is integrated into the impact prediction. The processes may be performed directly on the specific organization or on third party organization cooperating with the specific organization, for example as a customer, as a vendor, during a joint venture, as a partner, as a technological partner, as a local representative, as a subsidiary and the like.

The aggregated economic impact of the organization or a third party on the organization is the sum of all risk types and represents a situation where all the potential cyber events happen.

Calculating the probable Loss may be performed by running several different scenarios of cyber events on the organization or the third-party results.

The term “security event” refers to an attack performed on data or computer resources of an organization in order to steal or damage data and/or other resources. Examples of such event types include, but are not limited to, downtime, data theft, data loss, ransomware.

The term “organization”—refers to a company, a school, a firm, a non-profit organization (NGO), a computerized network, infrastructure, government-related entity having electronic equipment and the like.

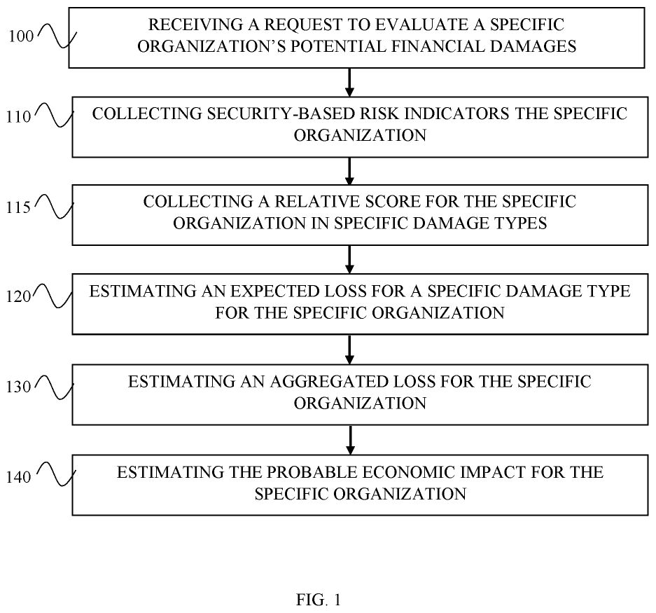

FIG. 1 shows a method of evaluating a financial risk of a specific organization due to potential security events, according to exemplary embodiment of the invention.

Step 100 discloses receiving a request to evaluate a specific organization's potential financial damages. The request may be received over the internet, for example via a web page enabling users to input data. The request may include general information about the specific organization, such as organization's name, address, URLs of web pages owned by or operated by the specific organization, key persons and the like.

Step 110 discloses collecting security-based risk indicators about the specific organization. The security-based risk indicators may include the number of open ports in the specific organization, the number of technologies used by the specific organization, the security vulnerabilities of the technologies used by the organization, leaked passwords of the specific organization, date of password leakage and the like. The security-based risk indicators may also include computerized tools available in the market to solve the vulnerabilities associated with the specific organization. As long as there are commonly available solutions, this may affect the specific organization's risk evaluation.

Step 115 discloses collecting a relative score for the specific organization in specific damage types. The collection may include computing the relative score using a software model, or receiving the relative score from another source. The relative score represents the likelihood of the specific organization to suffer a specific type of security event. As one cannot predict the probability for the occurrence of the security event, it is easier to compute the relative likelihood, compared to other organizations having their information stored in the model. The relative score may be in a specific range, for example between 0 and 100.

Step 120 discloses estimating an expected loss for a specific damage type for the specific organization. The expected loss of a specific damage type is computed by computing a range of expected loss. Computing the range includes receiving data about prior events of the same damage types. For example, the model receives 12,000 ransomware events, data about the organizations that suffered these events, the estimates damage in each of these events. This way, the model identifies correlation between data fields of the organizations and the damages. For example, organizations from the agriculture industry are expected to suffer lower damages relative to organizations in the finance sector. For example, for organizations of 500-1,000 employees based in Canada and operating in healthcare, the range of damages for ransomware would be between 0.14 million USD and 0.32 million USD per day, while the range of damages for data loss would be between 0.4 USD and 0.9 USD per lost data record. Then, the model places the specific organization in the range of the specific damage type based on the organization's relative score as collected in step 115. For example, in case the range is between 2 million USD and 4 million USD and the organization's relative score in ransomware is 0.8, the estimated damages would be 2.4 million USD (placing the organization in the range according to the relative score). This way, two organizations having the same size, sector and location and different risk-related indicators will have different estimated losses due to security events, meaning their premium for cyber insurance will be different.

Step 130 discloses estimating an aggregated loss for the specific organization. The aggregated loss of the organization is the sum of all risk types and represents a situation where all the potential cyber events happen. After computing the expected loss for a specific damage type for all the relevant damage types, the aggregated loss is computed by accumulating the expected losses in all the event types.

Step 140 discloses estimating the probable economic impact for the specific organization. The probable economic impact may be computed according to the specific organization's relative score in each event type. The relative score represents a likelihood that the specific organization will suffer from such event. For example, the specific organization's relative scores are [42, 55, 28, 84] in four different event types. The specific organization's estimated damages in the four different event types are [10M USD, 0.7M USD, 7.2M USD and 22.5M USD, M denotes one million]. Thus, the probable economic impact may be computed as 10M (1−0.42)+0.7M*(1−0.55)+7.2M (1−0.28)+22.5M*(1−0.84).

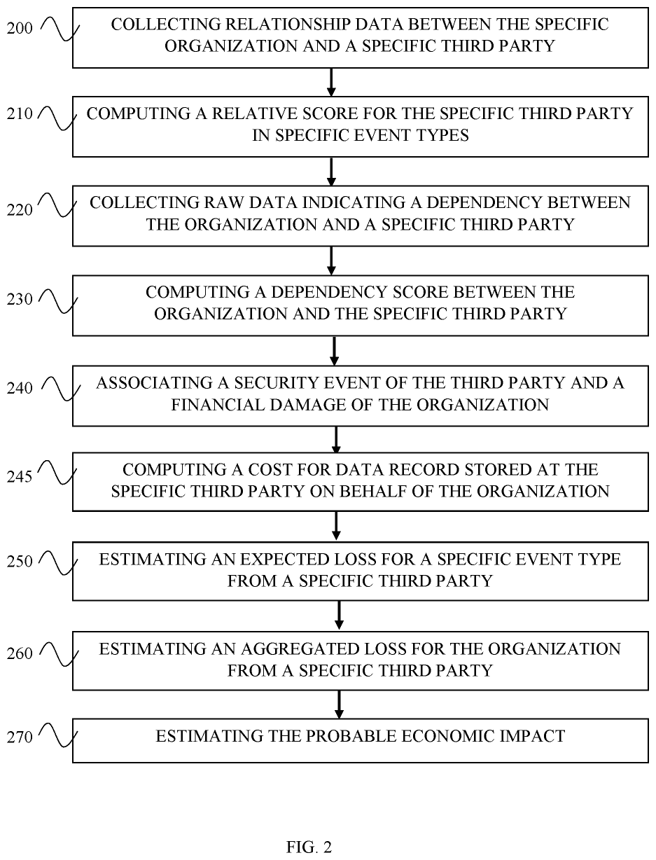

FIG. 2 shows a method of evaluating a financial risk of a specific organization due to potential security events that occur to a third party, according to exemplary embodiment of the invention.

Step 200 discloses collecting relationship data between the specific organization and a specific third party. The relationship data contains the information related to security events. For example, the type of services the third party provides for the specific organization, the number and type of information that the third party has access to on behalf of the specific organization, the number and type of information that the third party has access to on behalf of the specific organization's customers, the number and type of information that the third party locally stores on behalf of the specific organization, the persons working on the account of the specific organization at the third party, the persons' expertise and the like.

Step 210 discloses computing a relative score for the specific third party in specific damage types. That is, the relative score is computed for each damage type considered to be evaluated, not necessarily all possible damage types. The relative score may be computed by a software model, for example based on weights assigned to classifiers related to security. The specific third party is compared with the organizations in the model. The model obtains the weights for the classifiers based on the likelihood that the classifiers are related to security events. That is, a specific third party may have a higher relative score in one damage type and a lower relative score in one damage type based on the information collected about the third party and the model's output.

Step 220 discloses collecting raw data indicating a dependency between the organization and a specific third party. The raw data includes the specific organization's revenue, the specific organization's estimated loss in one or more security events.

Step 230 discloses computing a dependency score between the organization and the specific third party. the influencing element in Loss of Income estimation is the organization's revenue and dependency on the third-party. Therefore, when estimating the Loss of income component, the calculation will be a function of the organization revenue, the level of dependency on the third-party, and the profile score of the third-party. for example, in case the organization's revenue is 150 million USD and the dependency of the third-party is medium, the range of the dependency will be between 45% and 65%, or another predefined range. Then, the relative rank is computed in the range based on the third party's relative rank as computed in step 210. For example, in case the third-party's profile score is closer to 0, then the relative rank will be closer to 65%, and in case the third-party profile score is closer to 100, the percentile will be closer to 45%.

Step 240 discloses associating a security event of the third party and a financial damage of the organization. For example, in case the security event is ransomware, the financial damage includes business interruption. The financial damage differs from one organization to another, for example based on the organization's revenue. In addition, organizations with less employees with expertise in data security, and more general in information technology (IT) are more likely to suffer from the business interruption more days than other organizations. The financial damage may include indirect expenses, such as payment to Public Relations (PR) agencies, regulatory fines, court settlements and the like. Such indirect expenses may be associated with only a first group of security events, and are irrelevant to a second group of security events. The model may store a table or another format of information associating security events with financial damages that are relevant to each security event.

Step 245 discloses computing a cost for data record stored at the specific third party on behalf of the organization. The cost per data record is computed according to the organization's properties, such as an organization's number of employees, organization's business sector, location of the organization's headquarters, main operation/sales and the like.

Step 250 discloses estimating an expected loss for a specific event type from a specific third party. The expected loss if computed for a single security event type, such as downtime, data theft, data loss, ransomware and the like. The output may be a table in which the specific organization obtains a financial evaluation of the expected damages in case a specific event type occurs to the third parties cooperating with the specific organization. The estimates loss may be computed according to the relative score of the specific third party in a specific event type, as computed on step 210 multiplied with the expected damage for the organization in such event type.

As a specific organization has business relationships with multiple third parties, this enables the organization to estimate the financial risk resulting from the cooperation with a specific third party. The computation further enables the specific organization to estimate an alternative cost, in case the cooperation is altered from one third party to another third party. for example, in case a specific organization changes a vendor for accounting or consultancy, this may change the financial risk applied to the specific organization, even if the quality of the services may be very similar.

Step 260 discloses estimating an aggregated loss for the organization from a specific third party. The aggregated loss is the sum of all expected loss for all the specific event types.

Step 270 discloses estimating the probable economic impact of the specific organization from a third party. The probable economic impact is computed by multiplying a probability of the third party to suffer from a specific security event type and the expected financial damage of the specific organization from the specific security event type [P₁*D₁+P₂*D₂ . . . +Pn*Dn], Pn denotes the probability of occurrence of event type N and Dn denotes the damage of the specific organization from the specific event type.

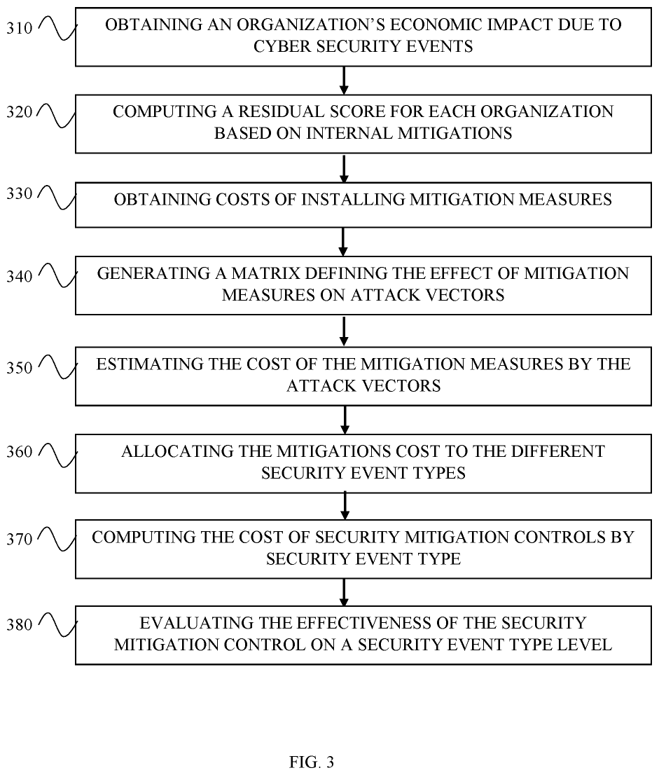

FIG. 3 shows a method of selecting an optimal security mitigation for reducing a security risk of an organization, according to exemplary embodiment of the invention.

Step 310 discloses obtaining an organization's economic impact due to cyber security events. The economic impact may be provided based on the process described above, or using other processes. The economic impact relates to a specific organization, or to a group of organizations. The economic impact is represented as a sum of money in a currency used by the system that outputs the economic impact, such as US dollars, Japanese Yen, Bitcoin, and the like. The economic impact may be stored in a memory address in an electronic device, such as a laptop, a server, a cellular phone and the like.

Step 320 discloses computing a residual score for each organization based on internal mitigations. the residual represents the actual risk of the specific organization once the organization taken the mitigative measures to reduce its cyber risk. The mitigation measures may be installing cyber technologies, enforcing data security procedures in the organization and the like. The residual score is computed separately for each security event. For example, security mitigations may reduce the estimated economic loss of event type #1 from 180K$ to 144 k$ and reduce the estimated economic loss of event type #4 from 480K$ to 250 k$. The residual score may be computed based on an online questionnaire filled by the organization's personnel.

Step 330 discloses obtaining costs of installing mitigation measures. The costs may be provided from a database, or inputted by a user operating the device used to perform the process disclosed herein. The costs may vary from one mitigation measure to another and among organizations, for example according to the organization's size, number of devices etc.

Step 340 discloses generating a matrix defining the effect of security mitigation on various attack vectors. The matrix is stored in the device used to perform the process. An attack vector is defined as a specific path, method, or scenario that can be exploited to break into an IT system, thus compromising its security. An attack vector may be exploited manually, automatically, or through a combination of manual and automatic activity. Some common attack vectors include exploiting buffer overflows, exploiting webpages and email supporting the loading and subsequent execution of JavaScript or other types of scripts without properly limiting their powers, exploiting networking protocol flaws to perform unauthorized actions at the other end of a network connection and phishing.

The matrix defines how, if at all, mitigation measures can reduce the financial risk in the specific organization. For example, security mitigation #1 has economic impact only on attack vector #1, security mitigation #2 has economic impact on attack vector #1 (40%) and on attack vector #5 (60%), security mitigation #3 has economic impact on attack vector #1, security mitigation #4 has economic impact only on attack vector #4, security mitigation #5 has economic impact only on attack vector #4, security mitigation #6 has economic impact on attack vector #1 (50%) and also on attack vector #15 (50%), security mitigation #39 has economic impact on attack vector #2 (30%), attack vector #3 (20%) and attack vector #5 (50%), and security mitigation #40 has economic impact on attack vector #3 (70%) and attack vector #15 (30%). A specific security mitigation may theoretically have impact on all the attack vectors, the sum of all impacts is 100 percent.

| | | Attack | Attack | Attack | Attack | Attack | | Attack |
|---|---|---|---|---|---|---|---|---|
| Security | Mitigation | Vectors | Vectors | Vectors | Vectors | Vectors | | Vectors |
| Mitigation | Cost | 1 | 2 | 3 | 4 | 5 | . . . | 15 |

| | | | | | | | |
|---|---|---|---|---|---|---|---|
| SQ 1 | $ 10,000 | 100% | | | | | |
| SQ 2 | $ 10,000 | 40% | | | | 60% | |
| SQ 3 | $ 10,000 | 100% | | | | | |
| SQ 4 | $ 50,000 | | | | 100% | | |
| SQ 5 | $ 3,500 | | | | 100% | | |
| SQ 6 | $ 10,000 | 50% | | | | | 50% |
| SQ 39 | $ 70,000 | | 30% | 20% | | 50% | |
| SQ 40 | $ 5,500 | | | 70% | | | 30% |

Step 350 discloses estimating the cost of the mitigation measures by the attack vectors. For each attack vector, a function is computed, accumulating the multiplications of security mitigation cost and the effect of the same security mitigation on the specific attack vector. For example, the cost of attack vector #1 is 10,000*100%+10,000*40%+10,000*100%+10,000*50%=29,000. Similarly, the cost of attack vector #1 is 0.3*70,000 (cost of mitigation #39)=21,000. The outcome of this process is the financial value of each attack vector.

Step 360 discloses allocating the mitigations cost to the different security event types. This may be performed by assigning weights that represent the effect of an attack vector on different risk types. For example, attack vector #1 (computed to cost $29,000) effects 50% on risk type #2 and 50% on risk type #3, hence contribute $14,500 to each risk type. Each risk type value is computed according to sum of all the relative impacts of the attack vectors and the computed cost of the attack vector. The outcome of this process is the financial value of each risk type.

Step 370 discloses computing the cost of security mitigation controls by security event type. The cost per risk type may be computed as a sum of multiplications of the attack vectors' impact on a risk type and the cost of the relevant risk type. For example, risk type #1 may be computed according to the following formula

RT₁=Σᵢ₌₁ⁿAVᵢ*Wₐᵥ_{ᵢ}_{,rt}_{₁}=AV₂*Wₐᵥ_{₂}_{,rt1}+AV₅*Wₐᵥ_{₅}_{,rt1}+AV₁₅*Wₐᵥ_{₁₅}_{,rt1}

In which W_{avi,rt1} denotes the weight of each attack vector on the risk type #1.

Step 380 discloses evaluating the effectiveness of the security mitigation control on a security event type level. The effectiveness may be computed by subtracting the cost of a security mitigation from a difference between an economic inherent loss and an economic residual loss. That is, whether or not the benefit from the security mitigation is higher than or lower than the sum the organization managed to save. The effectiveness may be evaluated using other metrices, such as ROI and the like.

The model is a software-based model operating on a server or any other one or more electronic devices having processing capabilities. The electronic device on which the model runs includes a processor and a memory for storing the instructions executed the processor. The instructions are configured to implement the processes disclosed above.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments disclosed herein for carrying out this invention.

1. A computerized method for evaluating an organization's potential financial damages caused by cyber security events, the method comprising:
receiving a request to evaluate a specific organization's potential financial damages caused by a cyber security event, the request comprises information about the specific organization;
collecting security-based risk indicators about the specific organization;
inputting the security-based risk indicators about the specific organization into a model, said model obtains ranges of financial damages for various security events;
computing a specific potential financial damages for the specific organization according to the security-based risk of the specific organization and the ranges of financial damages; and
generating a matrix defining a financial effect of various security mitigations on the different security event types, wherein computing the financial effect comprises
computing weights that represent an impact of various security mitigations on various attack vectors,
estimating a cost for treating specific attack vectors based on a cost of the various security mitigations multiplied by the weight that represent an impact of various security mitigations on the specific attack vector,
computing a cost for treating a specific security event type as a sum of multiplications of the costs for treating the specific attack vectors and weights that represent an impact of the specific attack vectors on the specific security event type, and
evaluating an effectiveness of the security mitigation on a security event type level by subtracting the cost of the security mitigation from a difference between an economic inherent loss and an economic residual loss.

2. The method of claim 1, further comprising computing a relative score for the specific organization in specific damage types, said relative score is relative to other organizations in the model.

3. The method of claim 1, further comprising estimating an expected loss from the specific security event type for the specific organization.

4. The method of claim 3, further comprising estimating an aggregated loss for the specific organization according to the expected loss for the specific security event type and a probability of occurrence of the specific security event type.

5. The method of claim 1, further comprising:
collecting relationship data between the specific organization and a specific third party; and
estimating an expected loss for the specific organization for a specific damage type for a security event suffered by the specific third party.

6. The method of claim 5, further comprising:
collecting raw data indicating a dependency between the specific organization and a specific third party; and
computing a dependency score between the specific organization and the specific third party.

7. The method of claim 5, further comprising associating a security event of the specific third party and a financial damage of the specific organization.

8. The method of claim 1, further comprising generating a data record of each organization comprising values for the security-based risk indicators and inputting the multiple records into the model.

9. The method of claim 8, wherein the data record further comprises non-security risk indicators of the specific organization.

10. The method of claim 1, wherein the security-based risk indicators are unique to each organization in the model.

11. The method of claim 1, wherein the security-based risk indicators comprise security vulnerabilities of the specific organization.

12. The method of claim 1, wherein the security-based risk indicators comprise technologies used by the specific organization.

13-18. (canceled)
